(19) United States
(12) Patent Application Publication
(10) Pub. No.: US 2001/0009583 A1
(43) Pub. Date: Jul. 26, 2001

(54) Secret key registration method, secret key register, secret key issuing method, cryptographic communication method and cryptographic communication system

(75) Inventor: Yasuyuki Murakami, Kyoto-shi (JP)

Correspondence Address: HOGAN & HARTSON L.L.P., 500 S. GRAND AVENUE, SUITE 1900, LOS ANGELES, CA, 90071-2611, US

(73) Assignee: MURATA KIKAI KABUSHIKI KAISHA

(21) Appl. No.: 09/767,055

(22) Filed: Jan. 22, 2001

(30) Foreign Application Priority Data
Jan. 25, 2000 (JP) 2000-16363

(51) Int. Cl. H04L 9/00

(52) U.S. Cl. 380/278

(57) ABSTRACT

At each entity, a plurality of passwords based on a basic password and one-way functions are generated and sent to the respective key issuing agencies (respective centers). These passwords are used by each entity to receive in a secured manner the secret keys of each entity issued by the respective key issuing agencies (respective centers). The number of passwords that need to be managed at each entity is decreased. The secret keys are readily issued in a secured manner for each entity by a plurality of key issuing agencies (centers).

### BACKGROUND OF THE INVENTION

The present invention relates to a secret key registration method and secret key register for registering secret keys of entities for use in cryptographic communication between the entities, a secret key issuing method for issuing a secret key of each entity, a cryptographic communication method and cryptographic communication system for performing cryptographic communication between the entities, and a memory product/data signal embodied in carrier wave for recording/transferring an operation program for use in these methods, device and system.

In the modern society called the advanced information society, important business documents and image information are transmitted and processed in the form of electronic information, using computer networks as the base. Such electronic information has the characteristic that it can be easily copied and copies are difficult to distinguish from the original; therefore, information security becomes an important issue. In particular, the realization of computer networks that satisfy such requirements as “sharing of computer resources”, “multiple access capabilities”, and “globalization” is essential to the establishment of the advanced information society, but these requirements contain elements that conflict with the issue of information security between intended parties. As effective techniques for overcoming such conflicting requirements, cryptographic techniques used in military and diplomatic fields in the past human history have been attracting attention.

Cryptography communication concerns exchanging information by rendering it unintelligible to other than intended parties. In cryptography communication, the process of converting the original message (plaintext) that anyone can comprehend into a message (ciphertext) incomprehensible to third parties is called an encryption process, and the reverse process, i. e., converting the ciphertext back to the plaintext, is called a decryption process. Cryptography refers to the whole process of encryption and decryption. Secret information, called an encryption key and a decryption key, is used in the encryption and decryption processes, respectively. Since a secrete decryption key is needed for decryption, only a person who knows the decryption key can decrypt the ciphertext, and the secrecy of information can thus be ensured by encryption.

The same key used for encryption may be used for decryption, or different keys may be used. Cryptography that uses the same key for encryption and decryption is called common key cryptography, a typical example of which is the Data Encryption Standards (DES) defined by the National Bureau of Standards of the U. S. Department of Commerce. Prior art common key cryptographic system can be categorized into the following three methods.

(1) First method

A method in which common keys for all potential recipients for cryptographic communication are stored in secrecy.

(2) Second method

A method in which keys are exchanged through preliminary communication each time there arises a need for cryptographic communication. (Key sharing method by Diffie-Hellman, key distribution method using a public key system, etc.)

(3) Third method

A method in which a sender entity and a recipient entity generate identical common keys independently of each other by using publicized identification (ID) information identifying a specific individual, such as the name, address, etc. of each user (entity), and without the need for preliminary communication. (Key predistribution system (KPS), ID-based non-interactive key sharing schemes (ID-NIKS), etc.)

The first method requires that the common key of communicating party should be stored in advance. The second method needs that preliminary communication for key sharing. The third method is a useful method since it eliminates the need for storing of common key and preliminary communication, and since the common key can be established with any intended party, when necessary, by using the publicized ID information of the party and unique secret parameters predistributed from a key issuing agency.

FIG. 1 is a diagram illustrating the principle of an ID-NIKS system implementing this method. The existence of a trustworthy center as a key registration/issuing agency is assumed, and a common key generation system is constructed around this center. In FIG. 1, the ID information identifying an entity A, such as the name, address, telephone number, etc. of the entity A, is represented by h(ID_{A}) using a hash function h(•). For any intended entity A, the center calculates a secret key S_{Ai} based on center public information {PCᵢ}, center secret information {SCᵢ}, and the ID information h(ID_{A}) of the entity A, as shown below, and distributes the secret key in secrecy to the entity A.

SAᵢ=Fᵢ({SCᵢ}, {PCᵢ}, h(ID_{A}))

The entity A generates a common key K_{AB} for encryption and decryption, for use with other intended entity B, by using the secret key {SAᵢ} of the entity A, the center public information {PCᵢ}, and the ID information h(ID_{B}) of the other entity B, as shown below.

K_{AB}=f({S_{Ai}}, {PCᵢ}, h(ID_{A}))

The entity B also generates a common key K_{BA} for use with the entity A in the same manner. If the relation K_{AB}=K_{BA} always holds, the keys K_{AB} and K_{BA} can be used as the encryption/decryption keys between the entities A and B.

The present inventors have proposed a variety of encryption methods, common key generating methods, cryptographic communication methods, etc. based on such an ID-NIKS, and also proposed an encryption method, common key generating method, cryptographic communication method and so on based on the ID-NIKS, which achieve higher security by dividing the ID information of each entity into a plurality blocks and distributing secret keys of the entity generated based on the divided ID information to the entity from a plurality of centers, respectively.

In these proposed methods, for example, each entity, who wishes to have its secret keys issued, accesses the homepage of each center and sends its password to each center according to a public key method via a server or directly by electronic mail. Each center encrypts its own secret information based on the password sent from each entity, i.e., uses a secret key method in which the password is incorporated into the center's secret information, and issues the secret key of each entity to the entity by, for example, electronic mail. Thus, since the secret key of each entity is issued in an encrypted form incorporating its password therein, it is possible to issue the secret key in a secured manner without causing the secret key to be known by other party.

While each entity sends its password to a plurality of centers, it is more preferred for security reasons that each entity sends unique passwords to the centers, respectively. In this case, however, it is necessary to manage a large number of passwords corresponding to the number of centers.

### BRIEF SUMMARY OF THE INVENTION

An object of the present invention is to provide a secret key registration method, secret key register, secret key issuing method, cryptographic communication method and cryptographic communication system capable of reducing the number of passwords to be managed by each entity, and to provide a memory product/data signal embodied in carrier wave for recording/transferring an operation program for use in these methods, device and system.

According to the present invention, each entity generates a plurality of passwords based on a basic password and a plurality of different one-way functions, sends the generated passwords to the respective key registration/issuing agencies (the respective centers), and receive its secret keys which have been encrypted based on the respective passwords from the key registration/issuing agencies (centers), respectively. Accordingly, since each entity who wishes to have its own secret keys issued generates a plurality of passwords corresponding to the number of the key registration/issuing agencies (the number of the centers), based on the basic password and a plurality of different one-way functions, and sends the generated passwords to the key registration/issuing agencies (centers), respectively, the number of passwords that need to be managed by each entity is decreased.

Besides, one-way hash functions are used as these one-way functions.

Moreover, each entity encrypts the respective passwords according to a public key method and sends the encrypted passwords to the key registration/issuing agencies (centers), respectively. It is therefore possible to send the passwords in a secured manner.

Furthermore, each entity sends the passwords and its electronic mail address to the respective key registration/issuing agencies (the respective centers) via a homepage on the Internet, and then each key registration/issuing agency (each center) issues a secret key of each entity by electronic mail. Thus, since each entity sends the passwords and its electronic mail address by using a homepage on the Internet, it is possible to encrypt the electronic mail address and send the encrypted electronic mail address to each key registration/issuing agency (each center), thereby further improving the security.

In addition, each entity sends the passwords to the respective key registration/issuing agencies (the respective centers) by electronic mail, and each key registration/issuing agency (each center) issues a secret key of each entity by electronic mail. Thus, since electronic mail is used to send the respective passwords from each entity, it is not necessary for each entity to particularly input its electronic mail address.

Besides, each key registration/issuing agency (each center) issues a secret key of each entity by using divided identification information obtained by dividing identification information of the entity. It is therefore possible to perform cryptographic communication between entities based on the ID-NIKS with high security,

The above and further objects and features of the invention will more fully be apparent from the following detailed description with accompanying drawings.

### BRIEF DESCRIPTION OF THE SEVERAL VIEWS OF THE DRAWINGS

FIG. 1 is an illustration showing the theoretical structure of an ID-NIKS system;

FIG. 2 is a schematic diagram showing the structure of a cryptographic communication system of the present invention;

FIG. 3 is a schematic diagram showing a state of information communication between two entities;

FIG. 4 is an illustration showing the internal structure of a secret key issuing device;

FIG. 5 is a schematic diagram showing an example of how an ID vector (identification information) of an entity is divided;

FIG. 6 is a flowchart showing a registration process performed at the entity a.

FIG. 7 is a flowchart showing a registration process performed at the entity b.

FIGS. 8A and 8B are flowcharts showing a registration process performed at an entity and a secret key issuing process performed at a center;

FIGS. 9A and 9B are flowcharts showing a common key generating process, encryption process and decryption process performed at two entities;

FIG. 10 is an illustration showing an example of an electronic mail address;

FIG. 11 is a flowchart showing a common key generating process performed at the entity a;

FIG. 12 is a flowchart showing a common key generating process performed at the entity b; and

FIG. 13 is an illustration showing the structure of an embodiment of a memory product.

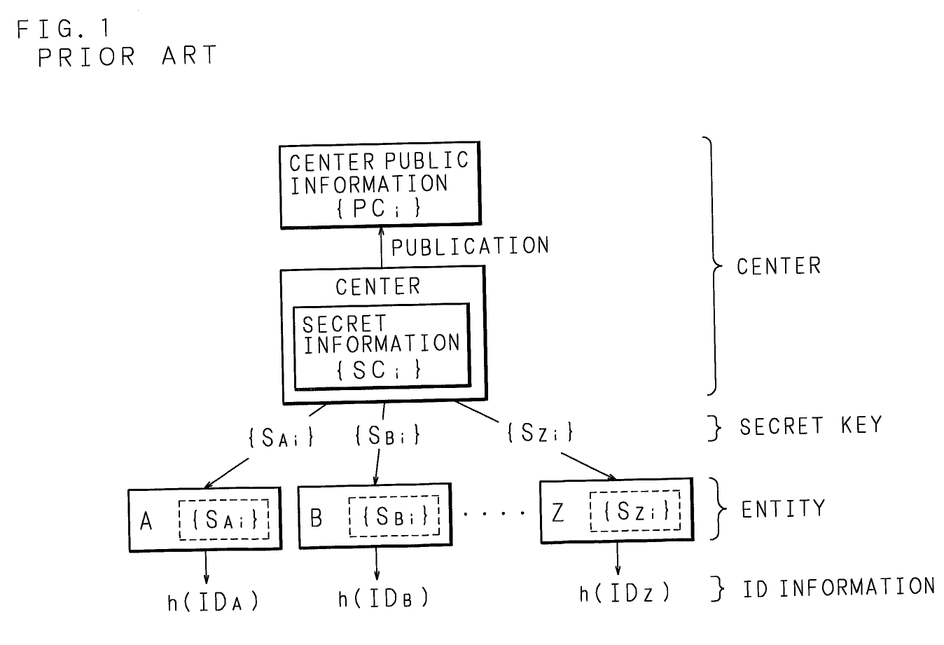

### DETAILED DESCRIPTION OF THE INVENTION

The following description will explain in detail an embodiment of the present invention.

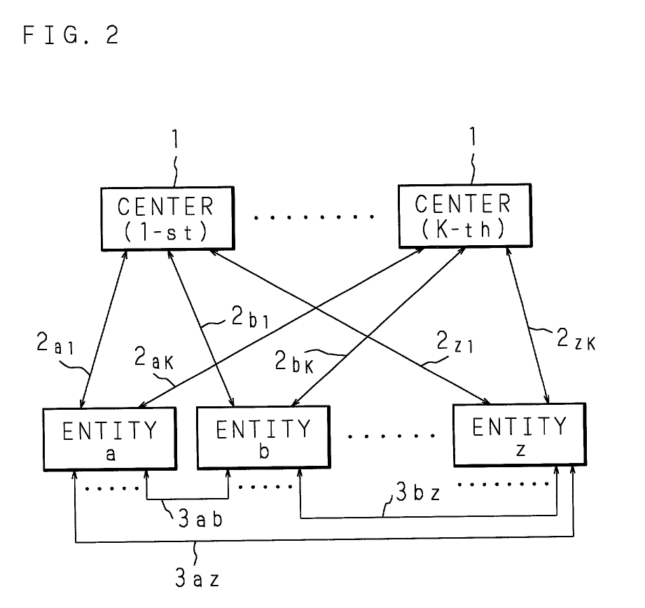

FIG. 2 is a schematic diagram showing the structure of a cryptographic communication system of the present invention. A plurality (number K) of centers 1, that is, the key registration/issuing agencies, which can be trusted for the secrecy of information are set as the servers for issuing secret keys. For example, public organizations in the society can be chosen as the centers 1.

Each of these centers 1 is connected to a plurality of entities a, b, . . . , z as the users of this cryptographic communication system via communication channels 2ₐ₁, . . . , 2_{aK}, 2_{b1}, . . . , 2_{bK}, . . . , 2_{z1}, . . . , 2_{zK}. Each center 1 is requested to issue secret keys by the respective entities a, b, . . . , z and issues the secret keys of the entities to the respective entities a, b, . . . , z via these communication channels. Moreover, communication channels 3ab, 3az, 3bz, . . . for electronic mail are provided between two entities so that a ciphertext obtained by encrypting communication information is transmitted and received mutually between the entities by electronic mail.

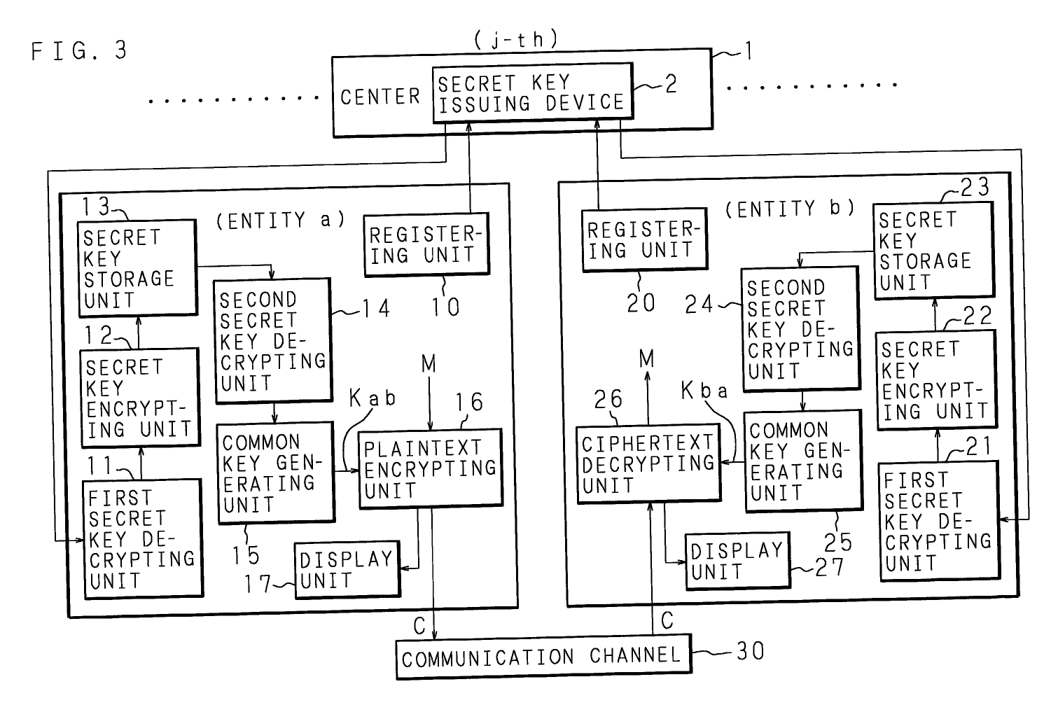

FIG. 3 is a schematic diagram showing a state of information communication between two entities, a and b. The example shown in FIG. 3 illustrates a case where the entity a encrypts a plaintext (message) M into a ciphertext C and transmits the ciphertext C to the entity b, and the entity b decrypts the ciphertext C into the original plaintext (message) M.

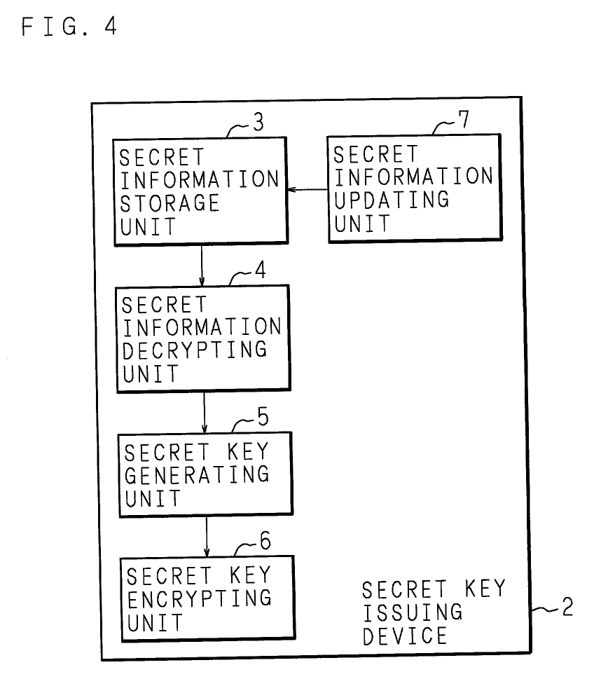

Each of a total of K centers 1 is provided with a secret key issuing device 2 for issuing a secret key of each of the entities a and b by selecting information corresponding to the respective entities a and b from its secret information (symmetric matrix) and encrypting the selected information based on the respective passwords of the entities a and b. As shown in FIG. 4 illustrating the internal structure of the secret key issuing device 2, the secret key issuing device 2 comprises: a secret information storage unit 3 for storing encrypted secret information; a secret information decrypting unit 4 for reading and decrypting the encrypted secret information stored in the secret information storage unit 3; a secret key generating unit 5 for generating secret keys of the entities a and b, respectively, based on the secret information of the center 1 itself and the identification information(ID information) of each of the entities a and b; a secret key encrypting unit 6 for encrypting the generated secret keys by the passwords inputted by the entities a and b, respectively; and a secret information updating unit 7 for encrypting the secret information of the center 1 updated at predetermined time intervals and for writing the encrypted secret information into the secret information storage unit 3.

The entity a comprises: a registering unit 10 for requesting each of the K centers 1 to issue a secret key; a first secret key decrypting unit 11 for decrypting the secret key of the entity a itself which is encrypted according to a secret key method and transmitted from each of the K centers 1; a secret key encrypting unit 12 for encrypting the K decrypted secret keys of the entity a; a secret key storage unit 13 for storing the encrypted secret keys; a second secret key decrypting unit 14 for reading and decrypting the encrypted secret keys stored in the secret key storage unit 13; a common key generating unit 15 for generating a common key K_{ab} desired by the entity a for use with the entity b, based on its own secret keys and the identification information (ID information) of the entity b; a plaintext encrypting unit 16 for encrypting the plaintext (message) M into the ciphertext C with the common key K_{ab} and for outputting the ciphertext C onto the electronic mail communication channel 30; and a display unit 17 for displaying the common key, plaintext, ciphertext, etc.

Similarly, the entity b comprises: a registering unit 20 for requesting each of the K centers 1 to issue a secret key; a first secret key decrypting unit 21 for decrypting the secret key of the entity b itself which is encrypted according to a secret key method and transmitted from each of the K centers 1; a secret key encrypting unit 22 for encrypting the K decrypted secret keys of the entity b; a secret key storage unit 23 for storing the encrypted secret keys; a second secret key decrypting unit 24 for reading and decrypting the encrypted secret keys stored in the secret key storage unit 23; a common key generating unit 25 for generating a common key K_{ba} desired by the entity b for use with the entity a, based on its own secret keys and the identification information (ID information) of the entity a; a ciphertext decrypting unit 26 for decrypting the ciphertext C inputted from the communication channel 30 into the plaintext (message) M with the common key K_{ba} and for outputting the plaintext M; and a display unit 27 for displaying the common key, plaintext, ciphertext etc.

Next, the following description will explain the operation of cryptographic communication in a cryptographic communication system having such a structure.

(Preparatory Process)

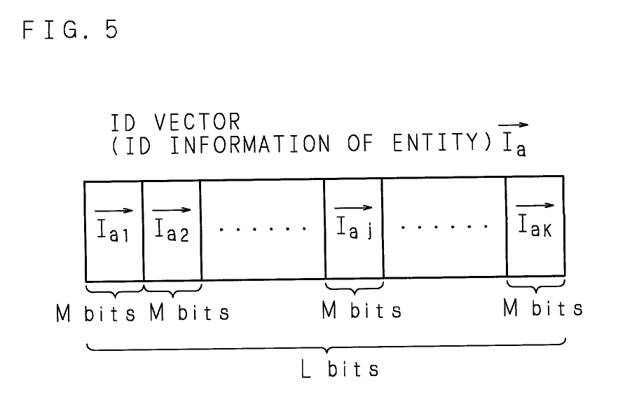

The identification information (ID information) identifying each entity, for example, an ID vector (L-bit binary vector) representing the electronic mail address of the entity, is divided into K blocks, each consisting of M bits, as shown in FIG. 5. For example, the ID vector (vector Iₐ) representing the electronic mail address of the entity a is divided as shown by equation (1). Each vector Iₐⱼ (j=1, 2, . . . , K) as the divided identification information will be referred to as the “ID division vector”. Here, the electronic mail address of the entity is transformed into the L-bit ID vector by a hash function.

\vec{Iₐ}=[\vec{Iₐ₁}|\vec{Iₐ₂}|. . . |\vec{Iₐₖ}] (1)

(Secret Key Issuing Process (Registration of Entity))

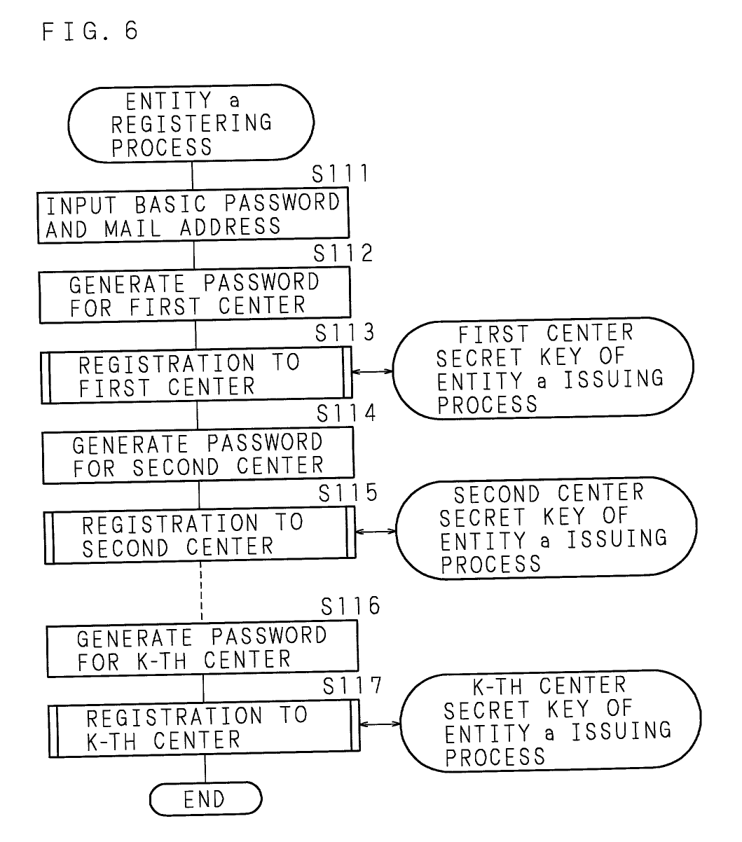

FIGS. 6, 7, 8A and 8B show a registering process to the centers 1 performed by the registering units 10 and 20 of the entities a and b, and a secret key issuing process performed by the secret key issuing device 2 of each center 1. The entities a and b who wish to participate in this cryptographic communication system, i.e., the entities a and b who wish to have their own secret keys issued, register to the respective centers 1 (the first center, second center, . . . , K-th centers) to obtain the secret keys.

First, as shown in FIG. 6, the entity a inputs a basic password and its electronic mail address into the registering unit 10 (S111). The registering unit 10 generates a password for the first center, based on the basic password and a one-way function (S112), and registers the generated password to the first center so as to obtain a secret key from the first center (S113).

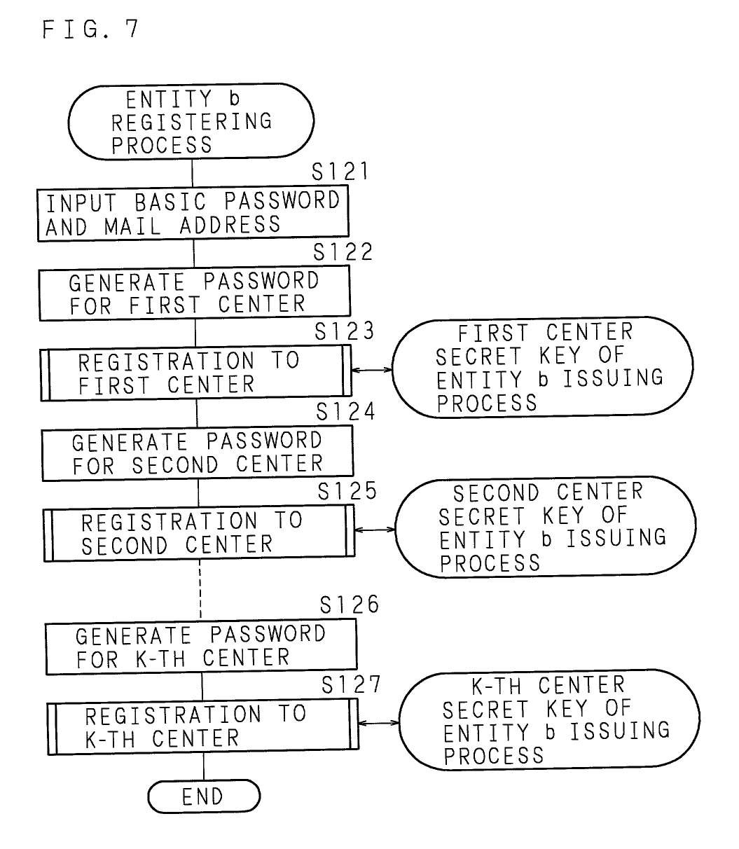

Similarly, passwords for the second center, . . . , K-th center are generated by using mutually different one-way functions and registered to the second center, . . . , K-th center, respectively, so as to obtain secret keys (S114 to S117). Likewise, as shown in FIG. 7, at the entity b, the registering process for each center 1 is performed by the registering unit 20 so as to obtain a secret key from each center 1 (S121 to S127).

In addition, a domain name is included in the electronic mail address used in the above-described (Preparatory Process) and (Secret Key Issuing Process (Registration of Entity)).

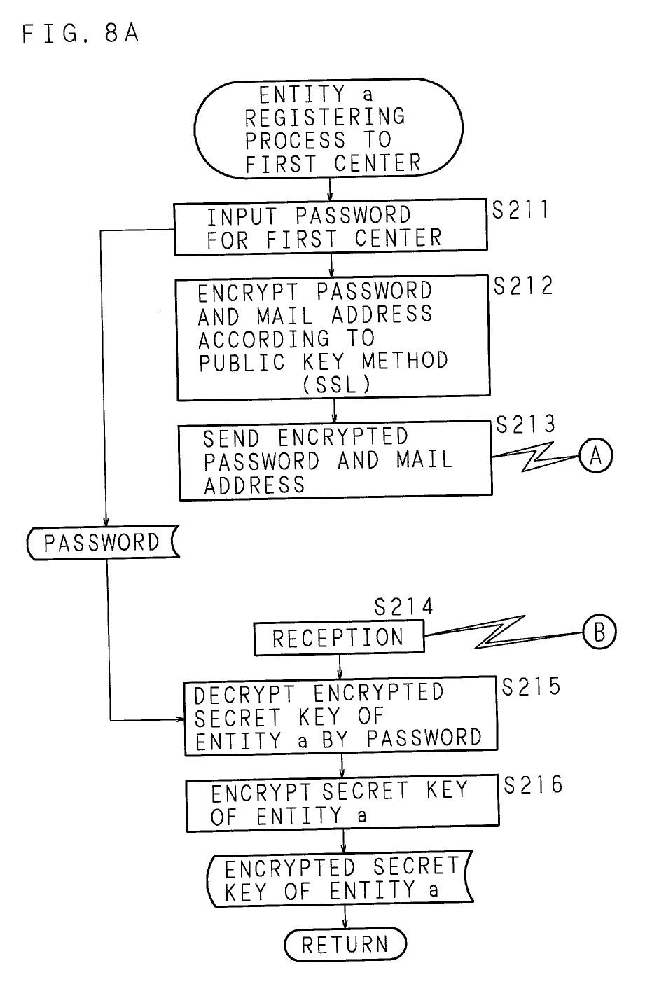

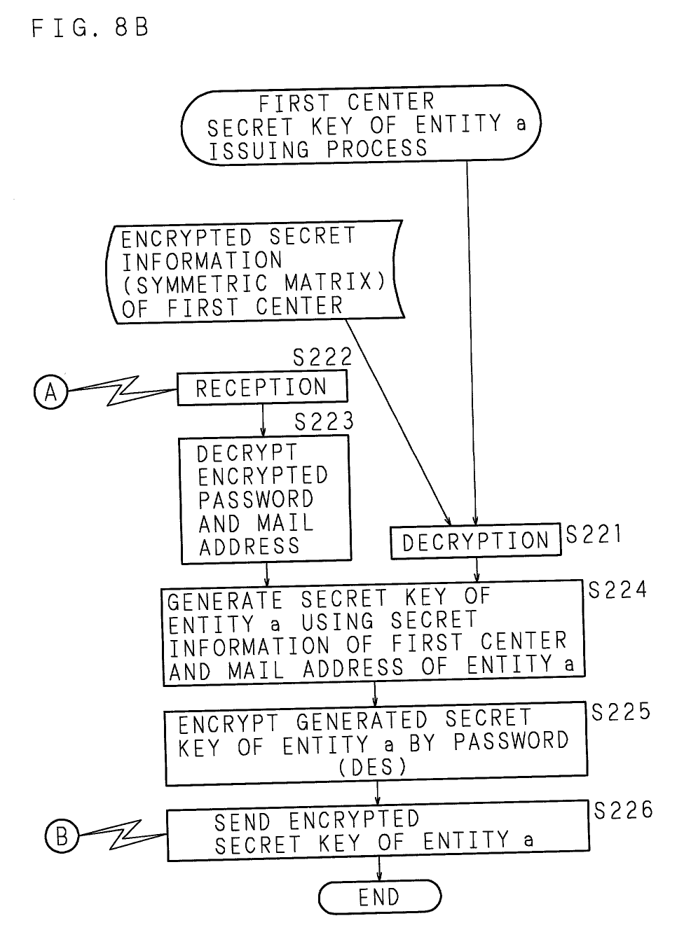

Next, referring to FIGS. 8A and 8B, the following description will explain the registering process with respect to the first center performed at the entity a and the secret key issuing process performed at the first center for the entity a. The registering process and the secret key issuing process are performed in the same manner at other entities and other centers.

The registering unit 10 of the entity a reads the password for the first center 1 generated at S112 (S211), accesses the homepage of the first center, encrypts the password and the electronic mail address of the entity a itself according to a public key method (SSL, etc.) and sends them to the first center via a server (S212, S213).

The secret key generating device 2 of the first center gains secret information (a later-described symmetric matrix) obtained by decrypting the encrypted secret information stored in the secret information storage unit 3 at the secret information decrypting unit 4 (S221). Moreover, the secret key generating device 2 receives the password and electronic mail address encrypted according to a public key method from the entity a (S222), and decrypts them (S223). At the secret key generating unit 5, a part corresponding to the ID division vector obtained from the electronic mail address of the entity a is selected from the secret information so as to generate a secret key (later-described secret key vector) of the entity a (S224).

The generated secret key (secret key vector) is encrypted based on the password received from the entity a (S225), i.e., the secret key of the entity a is issued to the entity a by electronic mail according to a secret key method in which the password is incorporated into the selected secret key (secret key vector) (S226). As the secret key method used in this step, it is possible to use DES. Incidentally, the electronic mail address of the entity a may be encrypted and then sent.

The entity a receives the encrypted secret key (secret key vector) of the entity a (S214), and decrypts it at the first secret key decrypting unit 11 by using the password (S215). Further, the decrypted secret key (secret vector) is once encrypted at the secret key encrypting unit 12 for security reasons (S216) and stored in the secret key storage unit 13.

Similarly, the entity a registers to the second center, . . . , K-th centers so as to obtain its secret keys. As described above, since a secret key (secret key vector) of each entity issued by each center 1 is sent to the entity after being encrypted by the password at the center 1 and then decrypted by the entity, each entity can obtain the secret key (secret key vector) in secrecy.

For security reasons, it is preferable to send a unique password to each center 1, but there is a possibility that the management of the passwords is complicated. Then, if a plurality of passwords are generated based on a single basic password and one-way function, it is possible to reduce the number of passwords that need to be managed. Moreover, by keeping the one-way function secret, the security can never be impaired.

For the generation of a plurality of passwords based on a single basic password and one-way function, it is possible to use the following methods.

\mathring{1} Using mutually different one-way functions for the respective centers 1.

\mathring{2} Using a common one-way function or mutually different one-way functions for the respective centers 1 after scrambling the basic password in different manners for the respective centers or adding a serial number to each center.

Further, it is possible to use a one-way hash function as the one-way function. Since the password after the operation by the one-way hash function has a shorter data length than the original basic password, if it is inconvenient, a password is constructed by combining the results of operations by a plurality of different one-way hash functions in a suitable manner. Accordingly, it is possible to compensate for a decrease in the data length due to the one-way hash function.

In addition, it is also possible to perform the registration of an entity and the secret key issuing process more simply by means of electronic mail. In this case, an entity who wishes to have its secret keys issued sends its password directly to each center 1 by electronic mail according to a public key method. Each center 1, in the same manner as the above, issues a secret key of the entity via electronic mail according to a secret key method (DES, etc.) in which the password inputted by the entity is incorporated into a secret key selected correspondingly to the entity from the secret information.

Incidentally, in the above-described example, while the secret key is issued by electronic mail, it is also possible to write the secret key of the entity on a removable recording medium, such as an IC card, and to send the recording medium to the entity.

Here, the following description will explain specifically the contents of the secret information (symmetric matrix) at each center 1 and the secret key (secret key vector) of each entity. The j-th (j= 1, 2, . . . , K) center 1 has, as the secret information, a symmetric matrix Hⱼ (2^{M}×2^{M}) having random numbers as components. Besides, the j-th center 1 issues for the entity a the row vector of the symmetric matrix Hⱼ that corresponds to the ID division vector Iₐⱼ of that entity a as the secret key (secret key vector). More specifically, Hⱼ [vector Iₐⱼ] is issued for the entity a. This Hⱼ [vector Iₐⱼ] denotes the vector of one row corresponding to the vector Iₐⱼ extracted from the symmetric matrix Hⱼ.

Here, examples of how the password is inputted at the entity side will be described. The following two examples of password input are preferable, particularly for entities who are not experienced in inputting passwords.

In one example, each entity inputs a character string, and the input data is encoded by base 64 to create a password. In this case, since 6-bit data can be expressed by inputting one character out of the 64 characters, if the password is 64 bits long, it is only necessary to input 11 characters.

In the other example, the password is inputted, in principle, by selecting characters from 16 kinds of characters consisting of numbers 0 to 9 and letters A to F, and if a character other than the 16 characters is inputted, the character is replaced by one character selected from 0 to 9 and A to F.

(Common Key Generating Process at Entities a and b)

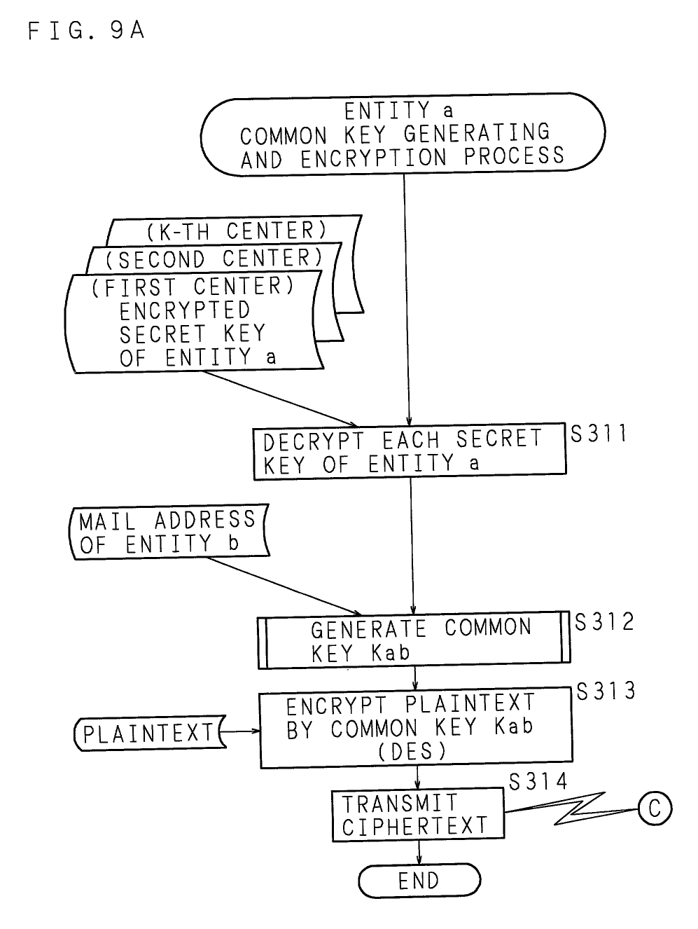

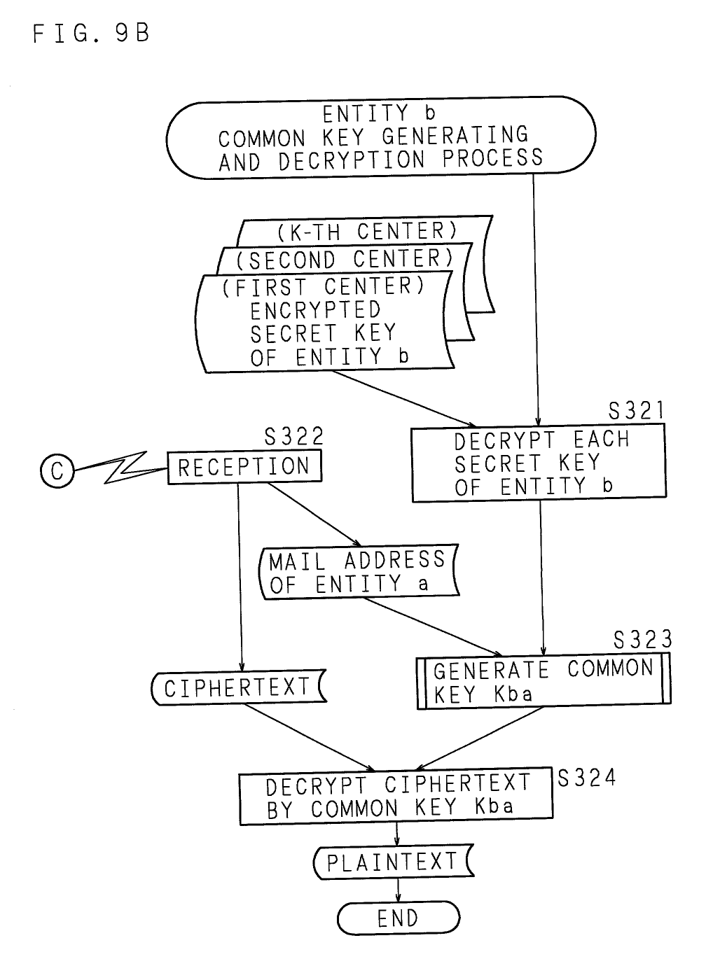

Referring to FIGS. 9A and 9B, the following description will explain the common key generating process performed at the entities a and b. For generation of common key K_{ab} (K_{ba}) for use with the entity b (entity a) designated as the communicating party, the entity a (entity b) reads from the secret key storage unit 13 (23) each encrypted secret key and decrypts it again into the secret key (secret key vector) at the second secret key decrypting unit 14(24) (S311 (S321)).

In order to generate the common key, the entity a (entity b) needs to have an electronic mail address as the identification information (ID information) of the entity b (entity a) designated as the communicating party. For the entity a as the sender, the electronic mail address of the entity b is given as the electronic mail address of the other party designated as the recipient. On the other hand, the entity b as the recipient can obtain the electronic mail address of the entity a from the sender's information (the FROM field, etc.) in the received electronic mail (S322).

The common key generating unit 15 (25) extracts an element corresponding to the entity b (entity a) based on the identification information (ID information) of the entity b (entity a) from the secret vector (secret key) received from each center 1 and combines a total of K elements to generate the common key K_{ab} (K_{ba}) of the entity a (entity b) for use with the entity b (entity a) (S312 (S323)). Here, both the common keys K_{ab} and K_{ba} agree with each other due to the symmetry of the secret information (matrix) held at each of the K centers.

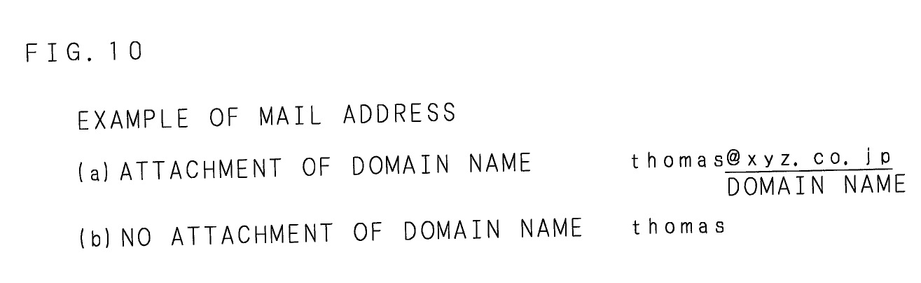

As the identification information (ID information) of the entity a and b, the electronic mail addresses are used. As shown in FIG. 10, there are two types of electronic mail addresses: one has a domain name given by a mail system (FIG. 10(a)); the other has no domain name (FIG. 10(b)). The electronic mail address with the domain name is used as the electronic mail address on the Internet. On the other hand, in mail systems other than the Internet, the electronic mail addresses without a domain name may be used.

In the LAN environment connected to the Internet through gateways, there are some occasions where either of these two types of electronic mail addresses may be used. For instance, in the area where the LAN, etc. is closed, it is possible to use either type of electronic mail address, and the electronic mail address with the domain name is used for the Internet mail through the gateways.

At the entities a and b, when a secret key (secret key vector) is obtained from each center 1 by the Internet electronic mail, the secret key (secret key vector) is generated based on the electronic mail address with the domain name. Therefore, if the electronic mail address of the communicating party for which a common key is to be generated has no domain name, the common key can not be generated correctly and cryptographic communication is infeasible.

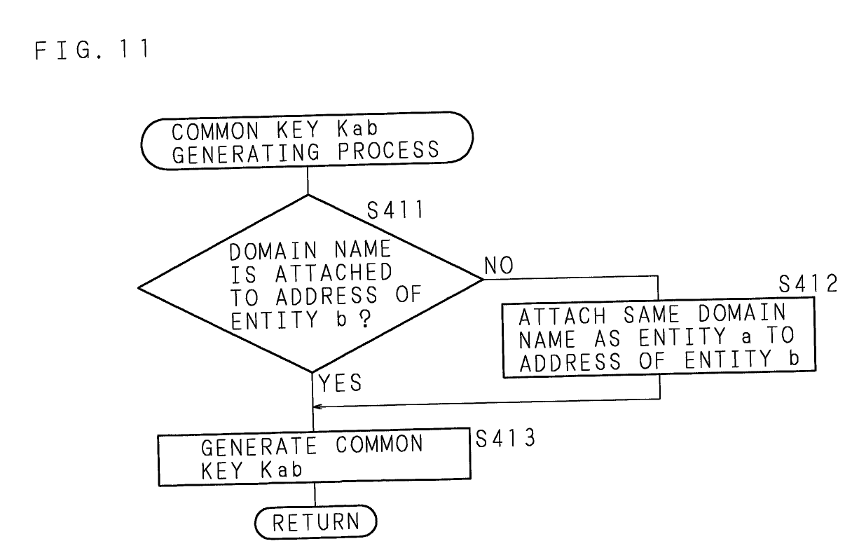

Then, as shown in FIG. 11, when the electronic mail address of the entity b designated as the communicating party has no domain name (S411: NO), the entity a as the sender gives the same domain name as the entity a (S412), and then generates the common key K_{ab} (S413).

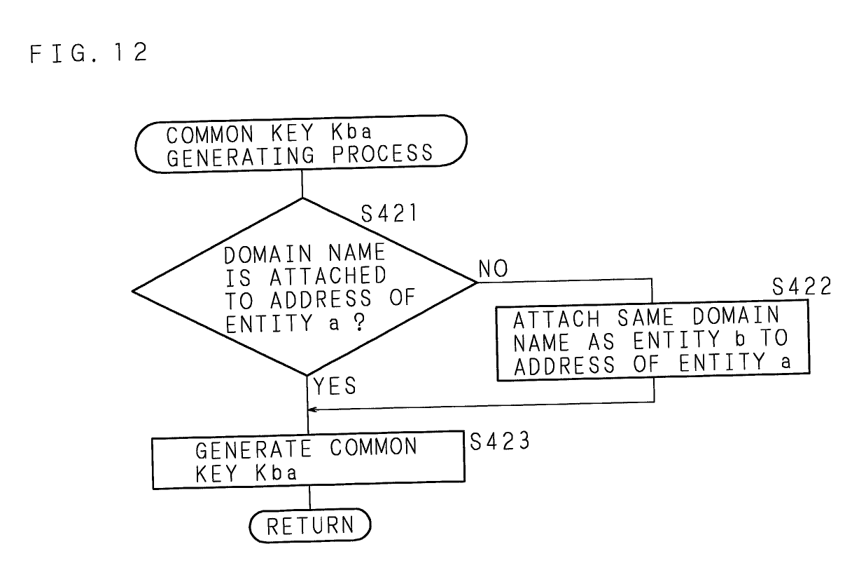

Besides, as shown in FIG. 12, when the electronic mail address such as the sender's information (the FROM field) of the electronic mail received from the entity a has no domain name (S421: NO), the entity b as the recipient gives the same domain name as the entity b (S422), and then generates the common key K_{ba} (S423).

(Encryption Process Performed at Entity a and Decryption Process Performed at Entity b)

Returning to FIGS. 9A and 9B, at the entity a, the plaintext (message) M is encrypted into the ciphertext C at the encrypting unit 16 by using the common key K_{ab} generated at the common key generating unit 15 (S313), and the ciphertext C is transmitted to the electronic mail communication channel 30 (S314). At the entity b, the ciphertext C is decrypted into the original plaintext (message) M at the decrypting unit 26 by using the common key K_{ba} generated at the common key generating unit 25(S324).

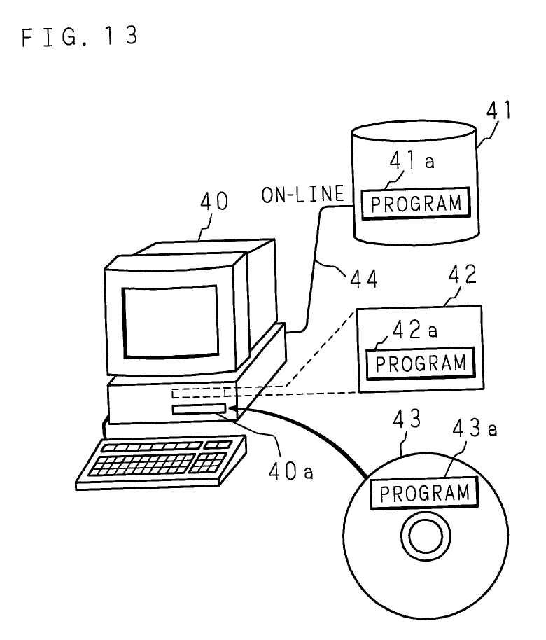

FIG. 13 is an illustration showing the structure of an embodiment of a memory product of the present invention. The program illustrated as an example here includes a registration process of requesting each center to issue a secret key; a secret key issuing process as described above for issuing the secret key of each entity at each center upon the request from the entity; a secret key decryption process at each entity as described above for decrypting the secret key issued by each center according to a secret key method; a common key generating process as described above for generating a common key for use with the communicating party by using its own secret keys; a process of storing and updating the secret information and secret key (secret vector) as described above for encrypting the secret information (symmetric matrix) of each center and each secret key (secret vector) of each entity; a display process as described above for displaying the common key, plaintext, and ciphertext; and/or an encryption process of encrypting the plaintext and a decryption process of decrypting the ciphertext. This program is recorded on a memory product as to be explained below. Besides, a computer 40 is provided for each center or for each entity.

In FIG. 13, a memory product 41 to be on-line connected to the computer 40 is implemented using a server computer, for example, WWW (World Wide Web), located in a place distant from the installation location of the computer 40, and a program 41a as mentioned above is recorded on the memory product 41. The program 41a read from the memory product 41 via a transfer medium 44 such as a communication channel controls the computer 40 to perform at least one of the above-described processes.

A memory product 42 provided inside the computer 40 is implemented using, for example, a hard disk drive or a ROM installed in the computer 40, and a program 42a as mentioned above is recorded on the memory product 42. The program 42a read from the memory product 42 controls the computer 40 to perform at least one of the above-described processes.

A memory product 43 used by being loaded into a disk drive 40a installed in the computer 40 is implemented using, for example, a removable magneto-optical disk, CD-ROM, flexible disk or the like, and a program 43a as mentioned above is recorded on the memory product 43. The program 43a read from the memory product 43 controls the computer 40a to execute at least one of the above-described processes.

As described in detail above, in the present invention, since an entity who wishes to have its secret keys issued generates a plurality of passwords corresponding to the number of centers, based on the basic password and one-way functions, it is possible to decrease the number of passwords that need to be managed by each entity.

As this invention may be implemented in several forms without departing from the spirit of essential characteristics thereof, the present embodiment is therefore illustrative and not restrictive, since the scope of the invention is defined by the appended claims rather than by the description preceding them, and all changes that fall within metes and bounds of the claims, or equivalence of such metes and bounds thereof are therefore intended to be embraced by the claims.

1. A secret key registration method for registering a secret key of each entity for use in cryptographic communication, comprising the steps of:
at each entity, generating a plurality of passwords based on a basic password;
sending the generated passwords to a plurality of key registration agencies, respectively; and
at each entity, receiving its secret keys which have been encrypted based on the respective passwords from the key registration agencies, respectively.

2. The secret key registration method as set forth in claim 1, wherein
the passwords are generated at each entity based on the basic password and a plurality of different one-way functions.

3. The secret key registration method as set forth in claim 2, wherein
each of the one-way functions is a one-way hash function.

4. The secret key registration method as set forth in claim 1, wherein
at each entity, the respective passwords are encrypted according to a public key method and the encrypted passwords are sent to the key registration agencies, respectively.

5. A secret key register for registering a secret key of each entity for use in cryptographic communication, comprising
a controller capable of performing the following operations:
(i) generating a plurality of passwords based on a basic password;
(ii) sending the generated passwords to a plurality of key registration agencies, respectively; and
(iii) receiving secret keys of each entity which have been encrypted based on the respective passwords from the key registration agencies, respectively.

6. The secret key register as set forth in claim 5 wherein
the passwords are generated based on the basic password and a plurality of different one-way functions.

7. The secret key register as set forth in claim 6, wherein
each of the one-way functions is a one-way hash function.

8. The secret key register as set forth in claim 5, wherein
the respective passwords are encrypted according to a public key method and the encrypted passwords are sent to the key registration agencies, respectively.

9. A secret key issuing method for issuing a secret key of each entity for use in cryptographic communication by each of a plurality of key issuing agencies, comprising the steps of:
at each entity, generating a plurality of passwords based on a basic password;
sending the generated passwords to the key issuing agencies, respectively; and
at the key issuing agencies, issuing secret keys of each entity which have been encrypted based on the respective passwords, respectively.

10. The secret key issuing method as set forth in claim 9, wherein
the passwords are generated at each entity based on the basic password and a plurality of different one-way functions.

11. The secret key issuing method as set forth in claim 10, wherein
each of the one-way functions is a one-way hash function.

12. The secret key issuing method as set forth in claim 9, wherein
at each entity, the respective passwords are encrypted according to a public key method and the encrypted passwords are sent to the key issuing agencies, respectively.

13. The secret key issuing method as set forth in claim 9, wherein
at each entity, the respective passwords and its electronic mail address are sent to the respective key issuing agencies via a homepage on the Internet, and at each key issuing agency, a secret key of each entity is issued by means of electronic mail.

14. The secret key issuing method as set forth in claim 9, wherein
at each entity, the respective passwords are sent to the respective key issuing agencies by means of electronic mail, and at each key issuing agency, a secret key of each entity is issued by means of electronic mail.

15. The secret key issuing method as set forth in claim 9, wherein
at each key issuing agency, a secret key of each entity is issued by using divided identification information obtained by dividing identification information of each entity.

16. A cryptographic communication method for transmitting information in ciphertext form between first and second entities, comprising the steps of:
at the first and second entities, generating a plurality of passwords based on a basic password;
sending the generated passwords to a plurality of key issuing agencies, respectively;
at each key issuing agency, generating and sending secret keys of the respective first and second entities which have been encrypted based on the respective passwords;
at the first entity, generating a first common key based on the secret keys of the first entity sent from the respective key issuing agencies and identification information of the second entity as a destination;
at the first entity, encrypting a plaintext into a ciphertext by using the generated first common key and transmitting the ciphertext to the second entity;
at the second entity, generating a second common key identical with the first common key, based on the secret keys of the second entity sent from the respective key issuing agencies and identification information of the first entity as a destination; and
at the second entity, decrypting the transmitted ciphertext into a plaintext by using the generated second common key.

17. The cryptographic communication method as set forth in claim 16, wherein
the passwords are generated at the first and second entities based on the basic password and a plurality of different one-way functions.

18. The cryptographic communication method as set forth in claim 17, wherein
each of the one-way functions is a one-way hash function.

19. The cryptographic communication method as set forth in claim 16, wherein
at the first and second entities, the respective passwords are encrypted according to a public key method and the encrypted passwords are sent to the respective key issuing agencies.

20. A cryptographic communication system for performing an encryption process of encrypting a plaintext as information to be transmitted into a ciphertext and a decryption process of decrypting the transmitted ciphertext into a plaintext mutually between a plurality of entities, comprising:
a plurality of entities for respectively generating a plurality of passwords based on a basic password and sending the generated passwords to a plurality of key issuing agencies; and
a plurality of key issuing agencies for respectively issuing secret keys of each entity which have been encrypted based on the respective passwords.

21. The cryptographic communication system as set forth in claim 20, wherein
each of the entities generates the passwords based on the basic password and a plurality of different one-way functions.

22. The cryptographic communication system as set forth in claim 21, wherein
each of the one-way functions is a one-way hash function.

23. The cryptographic communication system as set forth in claim 20, wherein
each of the entities encrypts the respective passwords according to a public key method and sends the encrypted passwords to the respective key issuing agencies.

24. A computer memory product having computer readable program code means for causing a computer to register a secret key of each entity for use in cryptographic communication, said computer readable program code means comprising:
program code means for causing the computer to generate a plurality of passwords based on a basic password;
program code means for causing the computer to send the generated passwords to a plurality of key registration agencies, respectively; and
program code means for causing the computer to receive secret keys of each entity which have been encrypted based on the respective passwords from the key registration agencies, respectively.

25. The computer memory product as set forth in claim 24, wherein
the passwords are generated on the basic password and a plurality of different one-way functions.

26. A computer data signal embodied in a carrier wave for transmitting a program, the program being configured to cause a computer to register a secret key of each entity for use in cryptographic communication, comprising:
a code segment for causing the computer to generate a plurality of passwords based on a basic password;
a code segment for causing the computer to send the generated passwords to a plurality of key registration agencies, respectively; and
a code segment for causing the computer to receive secret keys of each entity which have been encrypted based on the respective passwords from the key registration agencies, respectively.

27. The computer data signal embodied in a carrier wave as set forth in claim 26, wherein
the passwords are generated on the basic password and a plurality of different one-way functions.
